(19) United States
(12) Patent Application Publication
(10) Pub. No.: US 2018/0307219 A1
(43) Pub. Date: Oct. 25, 2018

(54) Causal Relation Model Verification Method and System and Failure Cause Extraction System

(71) Applicant: Hitachi, Ltd., Tokyo (JP)

(72) Inventors: Kazuki HORIWAKI, Tokyo (JP); Kei IMAZAWA, Tokyo (JP)

(21) Appl. No.: 15/911,610

(22) Filed: Mar. 5, 2018

(30) Foreign Application Priority Data
Apr. 19, 2017 (JP) 2017-083068

(51) Int. Cl. G05B 23/02; G06N 5/02

(52) U.S. Cl. CPC G05B 23/0248; G06N 5/022

(57) ABSTRACT

A system is provided in which a causal relation model acquired according to a manufacturing process data is efficiently used and verification according to domain knowledge is easily performed. There is provided a causal relation model verification method in an information processing device which includes an input device, a display device, a processing device, and a storage device. In the method, a first step is performed in which quality data which is an evaluation result of a resulting product, monitor data which indicates a parameter in a case where the resulting product is generated, and domain knowledge which indicates a mutual relation between the quality data and the monitor data are acquired from the input device or the storage device. In addition, a second step is performed in which the processing device constructs the causal relation model which defines a relation between nodes by setting the quality data and the monitor data to the nodes, using a causal relation model construction condition, which is acquired from the input device or the storage device. In addition, a third step is performed in which at least one of a comparison processing performed by the processing device and a comparison display performed by the display device is performed on the causal relation model and the domain knowledge.

### TECHNICAL FIELD

The present invention relates to a technology for extracting a failure cause or the like based on accumulated data.

### BACKGROUND ART

As the related art, JP-A-2008-84039 (PTL 1) discloses a technology for determining existence of correlation in such a way that manufacturing process data measured in a manufacturing facility is collected, correlation coefficients between respective variables are calculated by a correlation coefficient matrix operation section with respect to the collected manufacturing process data, a causal relation model is derived by a graphical modeling section, and the causal relation model acquired before being stored in a model database is compared with a correlation coefficient between variables acquired based on the manufacturing process data whenever the causal relation model is calculated.

In addition, JP-A-2013-3669 (PTL 2) discloses a technology for extracting a high-frequency combination by discriminating relations between connection graphs which are not connected to each other in a graph in a database. In addition, JP-A-2004-334841 (PTL 3) discloses a technology for performing management such that knowledge acquired from an individual experience is easily reused.

### CITATION LIST

### Patent Literature

PTL 1: JP-A-2008-84039

PTL 2: JP-A-2013-3669

PTL 3: JP-A-2004-334841

### SUMMARY OF INVENTION

### Technical Problem

As disclosed in PTL 1, there is a technology for generating and using the causal relation model according to the manufacturing process data.

In a manufacturing industry or the like, it is effective to construct the causal relation model indicative of a causal relation between monitor data acquired from a manufacturing process and quality data acquired from a testing process and to specify a failure cause. Here, in a case where domain knowledge (which will be described later) is applied to the causal relation model, it is effective to specify a meaningful causal relation. In contrast, in a case where there is a large number of data items and it is desired to verify the constructed causal relation model and the domain knowledge, time is needed.

PTL 2 discloses a method for extracting a high-frequency subset frost the graph in the graph database. However, in the method disclosed in PTL 2, it is not possible to extract the subset of the monitor data, which has influence on the quality data, without omission. In addition, in the method for extracting the subset, for example, even in a case where a frequency of a subset of the monitor data, which is not related to the quality data, is high, the subset is extracted.

PTL 3 discloses a method for accumulating information relevant to the domain knowledge in the database. However, in the method disclosed in PTL 3, it is not possible to verify the causal relation model and the domain knowledge which are acquired from the monitor data and the quality data and to automatically input a restriction condition of the domain knowledge.

Here, an object of the present invention is to provide a system in which the causal relation model acquired according to the manufacturing process data is efficiently used and verification according to the domain knowledge is easily performed.

### Solution to Problem

According to an aspect of the present invention, there is provided a causal relation model verification method in an information processing device which includes an input device, a display device, a processing device, and a storage device. In the method, a first step is performed in which quality data which is an evaluation result of a resulting product, monitor data which indicates a parameter in a case where the resulting product is generated, and domain knowledge which indicates a mutual relation between the quality data and the monitor data are acquired from the input device or the storage device. In addition, a second step is performed in which the processing device constructs the causal relation model which defines a relation between nodes by setting the quality data and the monitor data to the nodes, using a causal relation model construction condition, which is acquired from the input device or the storage device. In addition, a third step is performed in which at least one of a comparison processing performed by the processing device and a comparison display performed by the display device is performed on the causal relation model and the domain knowledge.

According to another aspect of the present invention, there is provided a failure cause extraction system which includes an input section, an initial causal relation model construction condition setting section, a data aggregation section, a causal relation model construction section, a subset extraction section, a subset and domain knowledge verification section, a causal relation model construction condition restriction setting section. The input section acquires monitor data which indicates a state of a product manufacturing process, quality data which is a result of a quality testing process of the product, a causal relation model construction condition which indicates a condition in a case where a causal relation model is constructed, and domain knowledge of a target manufacturing process. The initial causal relation model construction condition setting section sets an initial causal relation model construction condition, which is an initial condition in the case where the causal relation model is constructed, using the causal relation model construction condition. The data aggregation section aggregates the monitor data and the quality data as manufacturing data. The causal relation model construction section constructs the causal relation model on the manufacturing data and the initial causal relation model construction condition. The subset extraction section extracts a subset of the monitor data, which has prescribed or more influence on the quality data, based on the causal relation model constructed by the causal relation model construction section. The subset and domain knowledge verification section verifies the subset of the monitor data, which is extracted by the subset extraction section, and the domain knowledge. The causal relation model construction condition restriction setting section sets a causal relation model construction condition restriction which restricts the causal relation model construction condition in a case where a contradiction exists between the subset of the monitor data and the domain knowledge as a result of verification performed by the subset and domain knowledge verification section.

According to still another aspect of the present invention, there is provided a causal relation model verification system which includes an input device, a display device, a processing device, and a storage device. The system is capable of using quality data which is an evaluation result of a resulting product, monitor data which indicates a parameter in a case where the resulting product is generated, domain knowledge data which indicates a mutual relation between the quality data and the monitor data, and causal relation model construction condition data. The processing device constructs a causal relation model which defines a relation between nodes by setting the quality data and the monitor data as the nodes according to a condition indicated by the causal relation model construction condition data. The processing device stores the causal relation model in the storage device. The processing device detects mutual contrarieties according to a comparison processing performed on the causal relation model and the domain knowledge data. The processing device adds a restriction condition to a condition of the causal relation model construction condition data such that the detected contrarieties are solved, and corrects the causal relation model.

In a further preferable configuration of the causal relation model verification system according to the present invention, in a case where mutual contrarieties are detected by performing the comparison processing on the causal relation model and the domain knowledge data, the processing device extracts a subset, which includes a part of the monitor data that has prescribed or more influence on the quality data, in the causal relation model, and performs the comparison on the subset and the domain knowledge data.

### Advantageous Effects of Invention

It is possible to provide a system in which a causal relation model acquired according to manufacturing process data is efficiently used and verification according to domain knowledge is easily performed. Other objects, configurations, and effects will be apparent according to description of an embodiment below.

### BRIEF DESCRIPTION OF DRAWINGS

FIG. 1A is a conceptual diagram illustrating a causal relation model.

FIG. 1B is a conceptual diagram illustrating the causal relation model to which domain knowledge is reflected.

FIG. 1C is a conceptual diagram illustrating the causal relation model to which a magnitude of influence on quality data is reflected.

FIG. 1D is a conceptual diagram illustrating a subset acquired by extracting a part which has large influence on the quality data.

FIG. 2 is a block diagram illustrating an example of a configuration of a failure cause extraction system.

FIG. 3 is a plan view illustrating examples of a causal relation model display section, a subset display section, and a domain knowledge display section.

FIG. 4 is a plan view illustrating examples of the subset display section and the domain knowledge display section.

FIG. 5 is a flowchart illustrating an example of a processing flow of a control section.

FIG. 6 is a table illustrating an example of data definition of monitor data.

FIG. 7 is a table illustrating an example of data definition of the quality data.

FIG. 8 is a table illustrating an example of data definition of the domain knowledge.

### DESCRIPTION OF EMBODIMENTS

Hereinafter, an embodiment of the present invention will be described with reference to the accompanying drawings. Meanwhile, the same reference symbols are attached to the same parts as a principle throughout the drawings used to describe the embodiment, and repeated description thereof will be omitted.

In the specification, terms of “first”, second”, “third”, and the like are attached to identify components, and do not necessarily limit a number, an order, or content thereof. In addition, a number used to identify a component is used for each context, and a number used in one context does not necessarily indicate the same component in another context. In addition, a component identified by a certain number is not prevented from simultaneously performing a function of a component identified by another number.

A system, which is an example of an example, uses, for example, monitor data which indicates a state of an industrial product manufacturing process and quality data which is a result of a quality testing process. For example, various parameters, such as a voltage of a device, a current, a temperature of the manufacturing process, and pressure, are taken into consideration as the monitor data, and content thereof is not particularly limited. In addition, the quality data includes various specifications, such as an impurity, a size, and a failure frequency, of a manufactured product, and content thereof is not particularly limited. Although a method for collecting the data may be performed manually or automatically, the data is prepared as data which can be used by a calculator included in the system. In the system, a causal relation model is constructed based on the monitor data and the quality data.

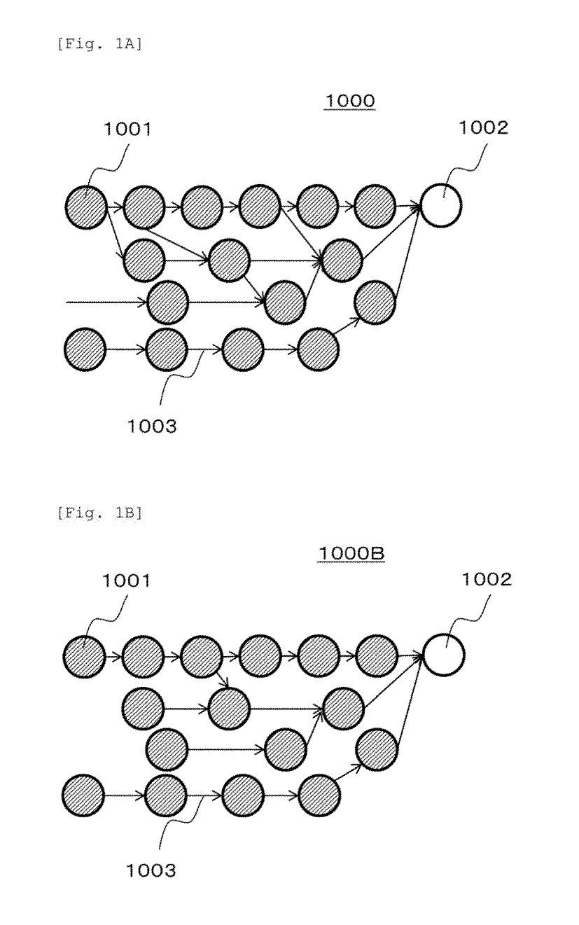

FIG. 1A illustrates a conceptual diagram of the causal relation model. Although an example of the causal relation model is also disclosed in PTL 1, the monitor data and the quality data are basically expressed as nodes. Furthermore, a relation between the nodes is defined by a link indicative of a causal relation, and is configured as free-shaped model data. As illustrated in FIG. 1A, a monitor data node 1001 is associated with a quality data node 1002 through a link 1003, thereby configuring the causal relation model 1000.

The system according to the example includes an input section that acquires a causal relation model construction condition which indicates a condition in a case where the causal relation model is constructed and that acquires domain knowledge of a target manufacturing process. The causal relation model construction condition is a condition in a case where the causal relation model is configured, and defines, for example, the number of nodes, the number of links connected to a node, a condition of a depth of the link, or a rule such as a sequence of the monitor data. In addition, a condition relevant to prohibition or addition of the link with respect to a specific node may be included. Although a method for generating the causal relation model construction condition may be performed manually or automatically, the condition is prepared as data which can be used by a calculator included in the system after input.

The domain knowledge of the manufacturing process is a mutual relation between the monitor data and the quality data defined based on a physical law or an experimental rule. For example, the domain knowledge includes “a positive (negative) correlation exists between a current and a voltage in the monitor data”, “a correlation does not exist between temperature 1 and temperature 2 in the monitor data”, and the like, and basically has a data structure (monitor data A, monitor data B, and relation). The quality data may be used instead of the monitor data. Although a method for generating the domain knowledge may be performed manually or automatically, the domain knowledge is prepared as data which can be used by the calculator included in the system after input.

A detailed configuration according to the example is provided with an initial causal relation model construction condition setting section that seta an initial condition in a case where the causal relation model is constructed, a data aggregation section that aggregates the monitor data and the quality data as manufacturing data, and a causal relation model construction section that constructs the causal relation model based on the manufacturing data aggregated by the data aggregation section and an initial causal relation model construction condition set by the initial causal relation model construction condition setting section. The causal relation model construction condition may be used as the initial condition without change.

In one aspect of the example, the domain knowledge is applied with respect to the causal relation model, and it is verified whether or not a contradiction exits between the domain knowledge and the causal relation model. In a case where the contradiction exists, the causal relation model is corrected. For example, in a case where domain knowledge “a correlation (or causal relation) does not exist between temperature 1 and temperature 2 in the monitor data” exists, a link between the temperature 1 and the temperature 2 of the monitor data is removed.

FIG. 1B illustrates a conceptual diagram of a corrected causal relation model. In a corrected causal relation model 1000B, a link 1003 which is contradictory to the domain knowledge is removed from the causal relation model 1000, and thus the processing becomes efficient. Otherwise, a link which does not exist in the causal relation model 1000 is added based on the domain knowledge.

In addition, in one aspect of the embodiment, a subset extraction section is provided that extracts a subset of the monitor data, which has influence on the quality data, based on the causal relation model constructed by the causal relation model construction section.

FIG. 1C illustrates a concept of extraction of the subset of the monitor data. As illustrated in FIG. 1C, a subset, which is connected by links 1003A of thick arrows, has large influence on the quality data, and a subset, which is connected by links 1003B of thin arrows, has small influence on the quality data. A scale of the influence enables an index based on strength of the causal relation between the monitor data and the quality data to be calculated and evaluation based on the index to be performed. An example of the index includes a difference in expected values of the monitor data in a case where different qualities appear.

That is, in a case where a network model to be used is a model to be generated, it is possible ta generate, for example, data in which a non-defective product is generated and data in which a defective product is generated. Here, for example, 1000 samples of the monitor data are prepared in a case where the product quality indicates the non-defective product, 1000 samples of the monitor data are prepared in a case where the product quality indicates the defective product, average values (expected values) are calculated for respective variables (nodes), and a difference in the average values is set to the index. According to the method, it is possible for the difference in the expected values to indicate a degree in which the monitor data affects the product quality.

FIG. 1D illustrates a concept of the extracted subset 1000C of the monitor data. The system according to the example includes a subset and domain knowledge verification section that verifies the subset of the monitor data, which is extracted by the subset extraction section, and the domain knowledge, and a causal relation model construction condition restriction setting section that inputs a restriction to the causal relation model construction condition in a case where a contradiction exists between the subset of the monitor data and the domain knowledge as a result of verification performed by the subset and domain knowledge verification section, in where verification is performed with respect to a part (subset), which is connected by the links 1003A of FIG. 1D, by applying the above domain knowledge, it is possible to reduce processing loads of an information processing device.

The example provides a system in which the strength of the causal relation is taken into consideration, it is possible to extract the subset of the monitor data without omission, the subset and the domain knowledge are verified, and the domain knowledge restriction condition is automatically inputted. Hereinafter, a configuration and a processing of the example will be described in detail.

(1) System Configuration

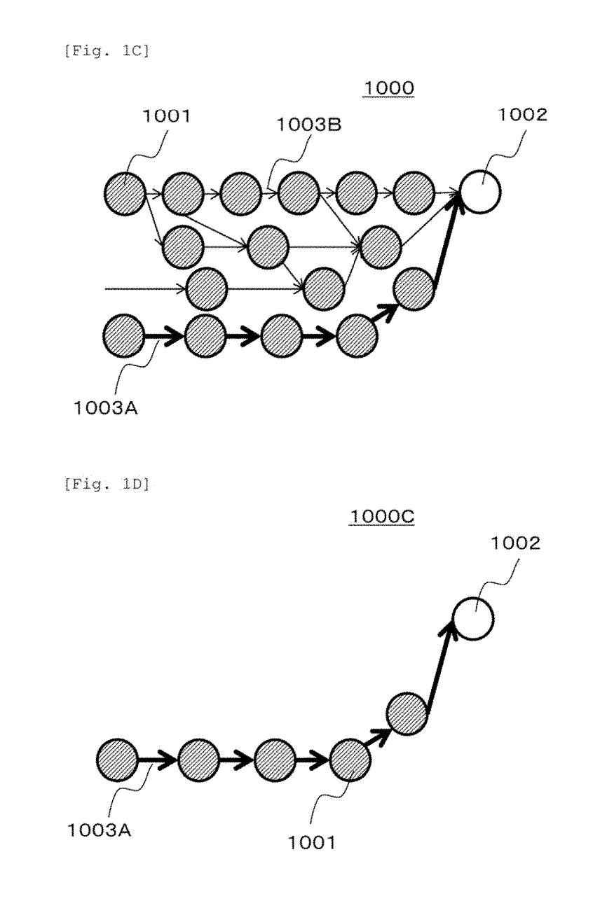

FIG. 2 illustrates an example of a configuration of the system according to the embodiment. It is possible to configure a system 1 using a general calculator (PC or the like) which includes a processing device, a storage device, an input device, and an output device. In the calculator, a characteristic processing of the example is realized in such, a way that the processing device executes, for example, a software program stored in the storage device. There is a case where a program performed by the calculator, a function thereof, or means which realizes the function is referred to as a “function”, “means”, a “section”, a “unit”, a “module”, and the like.

As illustrated in FIG. 2, the above configuration may be configured by a single computer or may be configured by another computer to which an arbitrary part of the input device, the output device, the processing device, or the storage device is connected via a network or the like. The system 1 includes an input and output section 10, a display section 20, a control section 30, a storage section 40, a bus, and the like.

The input and output section 10 includes an input device that is used to input a setting item of the causal relation model and an item on a Graphical User Interface (GUI), and is used to input the domain knowledge and the causal relation model construction condition according to an operation of a user, and an output device that is used to output content of the extracted subset, a result of the verification of the subset and the domain knowledge, and the like. Specifically, the input device includes, for example, a keyboard, a mouse, or the like. Specifically, the output device includes a display, a printer, or the like. The input and output section 10 may include an interface used to input and output data to and from the outside via the network. In the system, the GUI is configured by the display section 20 and various pieces of information are displayed on a display device such as a display.

The control section 30 is configured in such a way that, for example, the processing device (CPU) executes a software program stored in the storage device (memory). The control section 30 includes an initial causal relation model construction condition setting section 31, a data aggregation section 32, a causal relation model construction section 33, a subset extraction section 34, a subset and domain knowledge verification section 35, and a causal relation model construction condition restriction setting section 36. The control section 30 is a part that performs a processing which realizes a characteristic function of the example.

The initial causal relation model construction condition setting section 31 is a part that sets an initial condition, which is used in a case where the causal relation model is constructed, based on the causal relation model construction condition stored in a causal relation model construction condition storage section 43 and a causal relation model construction condition restriction stored in a causal relation model construction condition restriction storage section 48.

The data aggregation section 32 is a processing section that aggregates the monitor data and the quality data, for each product using the monitor data stored in the monitor data storage section 41 and the quality data stored in the quality data storage section 42.

The causal relation model construction section 33 is a part that constructs the causal relation model using the data aggregated by the data aggregation section 32 as input based on the condition set by the initial causal relation model construction condition setting section 31. As an example of a method for generating the causal relation model, a condition, which is set by the initial causal relation model construction condition setting section 31, is set as a restriction condition, and a combination between possible nodes may be included.

The subset extraction section 34 is a part that performs a process of extracting the subset of the monitor data, which has influence on qualities, based on the causal relation model acquired by the causal relation model construction section 33. In a case where the subset is extracted, it is possible to reduce subsequent processing loads.

The subset and domain knowledge verification section 35 is a part that verifies the subset of the monitor data acquired fay the subset extraction, section 34 and the domain knowledge stored in the domain knowledge storage section 47. In a case where the domain knowledge is applied to the causal relation model and contrarieties are solved, it is possible to specify a causal relation meaningful for the qualities.

The causal relation model construction condition restriction setting section 36 is a part that performs conversion on the result of verification acquired by the subset and domain knowledge verification section 35 into the causal relation model construction condition restriction.

The storage section 40 is configured with, for example, a well-known element such as a magnetic disk device (HDD) or a magneto-optic disk device (MO), and includes the causal relation model, the subset, a subset extraction index, and relevant data information (for example, a database and a table). In addition, each piece of data information, the program, and the like may have a format which is acquired and referred to from the outside via a communication network.

Meanwhile, although not illustrated in the drawing, the system 1 includes a well-known element, such as an operation system (OS), middleware, and an application, and has an existing processing function of displaying a GUI screen in a Web page format or the like. In addition, the display section 20 performs a processing of drawing and displaying a prescribed screen, and processes of the data information input by the user on the screen using the existing processing function.

(2) Display Section 20

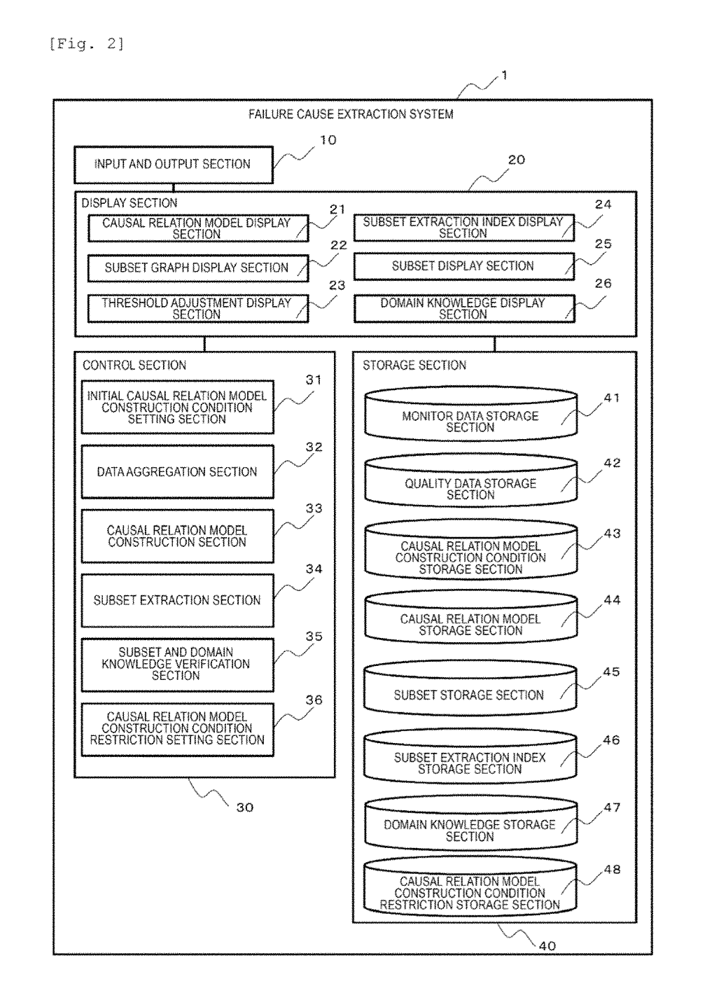

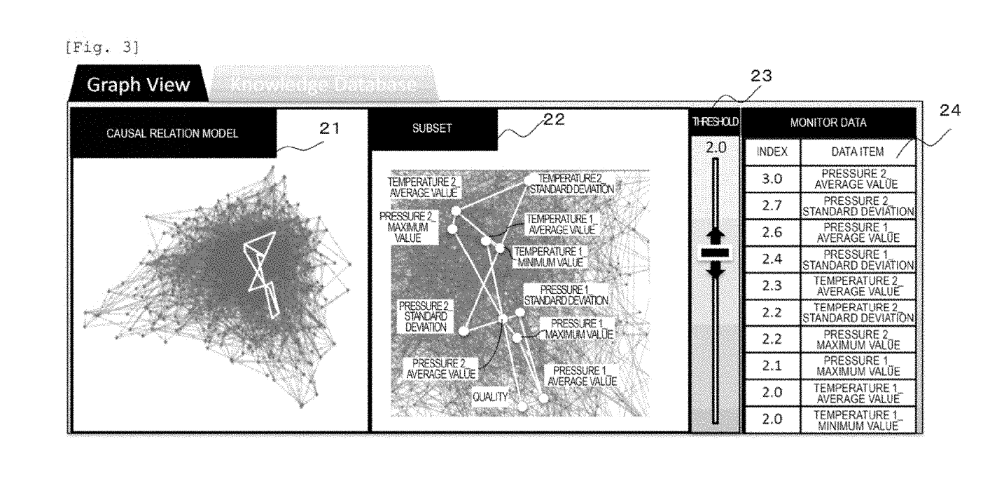

An example of the GUT screen displayed on the display section 20 will be described with reference to FIGS. 3 and 4. The GUI screen mainly includes a causal relation model display section 21, a subset graph display section 22, a threshold adjustment display section 23, and a subset extraction index display section 24.

In FIG. 3, the causal relation model display section 21 displays the causal relation model acquired by the causal relation model construction section 33 in a graph format. A part of the subset, which will be described later, may be specified at a part of the graph.

The subset graph display section 22 is a processing section that displays subsets of the monitor data, which have influence on the quality data acquired by the subset extraction section 34 in a graph format. In the example of FIG. 3, the subset graph display section 22 enlarges a part of the causal relation model and displays the enlarged part. In a case where the subsets of the monitor data are displayed, the extracted monitor data may be emphasized using circle symbols or the like, and connections of causal relations between the monitor data and between the monitor data and the quality data may be highlighted using straight lines. In addition, as illustrated in FIG. 3, content of the extracted monitor data may be displayed. In addition, the subset graph display section 22 has a processing function of displaying a changed subset of the monitor data again in a case where the subset of the monitor data to be displayed is changed by a GUI which changes a threshold.

The threshold adjustment display section 23 includes a processing section that displays a threshold of an index to be used in a case where the monitor data which has influence on the quality data is extracted as a subset, and a GUI which changes the threshold. As described above, the index indicates the strength of the causal relation between the monitor data and the quality data, and is, for example, the difference in the expected values. In a case where the threshold of the index is changed, items, displayed on the subset graph display section 22 and the subset extraction index display section 24, are changed. That is, since the threshold is set to 2.0 in the example of FIG. 3, the items to be displayed on the subset extraction index display section 24 are limited to items which have an index that is equal to or larger than 2.0. However, in a case where the threshold is changed, the items to be displayed on the subset extraction index display section 24 are changed.

The subset extraction index display section 24 is a processing section that displays the monitor data, which is used in the subset of the monitor data, which has influence on the quality data, for each threshold based on the causal relation model in the subset extraction section 34.

The subset display section 25 of FIG. 4 is a processing section that displays the subset of the monitor data, which has influence on the quality data and which is acquired by the subset extraction section 34, in a two-dimensional format using the data items of the monitor data and the quality data. A name (an ID or the like may be used) of the monitor data is disposed on a vertical axis and a horizontal axis, the existence of the link is set to “1”, and the non-existence of the link is set to “0”.

The domain knowledge display section 26 displays the domain knowledge input by the input and output section. In the example, domain knowledge is expressed as non-existence of the cause in a case where the domain knowledge is “0”, existence of the cause in a case where the domain knowledge is “1”, and the existence/non-existence of the cause is not clear in a case where the domain knowledge is “N”. In addition to the existence or non-existence, the strength of the causal relation may be gradually shown by numerical values.

It is possible for the user to grasp the subset of the monitor data which has influence on the quality data based on the output in the display section 20. For example, it is possible to recognize a location of a subset graph with respect to a whole graph by the causal relation model display section 21 and the subset graph display section 22. In addition, it is possible to recognize the subset of the monitor data, which has large influence with respect to the quality data, according to a priority based on a size of the index from the data items which are displayed according to the size of the index by the subset extraction index display section 24.

Furthermore, in a case where the subset display section 25 is compared with the domain knowledge display section 26, it is possible to compare the subset of the monitor data, which has large influence on the quality data, with the domain knowledge. In a case where a set of the monitor data is compared with the domain knowledge, it is possible to specify the set of the monitor data, which is not contradictory to the domain knowledge and has a large index, as a failure cause. Therefore, even in a case where there is a large number of data items, it is possible to reduce time required to verify the subset of the monitor data, which has influence on the quality data, and the domain knowledge, and to specify the failure cause. In the above-described processing, even in a case where the information processing device automatically performs calculation, it is possible to acquire the same advantage.

Comparison of the subset of the monitor data with the domain knowledge may be performed through comparable display on a screen as illustrated in FIG. 4, and it is possible to cause the user to view and to manually perform an operation. Otherwise, it is possible to perform a comparison processing as data, in the system together with the display or without the display. For this, both the set of the monitor data and the domain knowledge may have a comparable data structure such as (a parameter that specifies first data, a parameter that specifies second data, and a parameter that specifies a relation between the first data and the second data). Here, the data includes the monitor data and the quality data. In a case where the data as described above is compared as a correspondence table of respective variables (monitor data) as illustrated in FIG. 4, verification becomes easy.

The comparison processing may be, for example, a part of the function of the subset and domain knowledge verification section 35 which will be described later. The processing is performed by comparing, for example, parameters which indicate a relation corresponding to a set of the parameter which specifies the first data and the parameter which specifies the second data between the subset and the domain knowledge, the parameters being the same. For example, in a case where the subset is “1 (existence of the link)” and the domain knowledge is “0 (non-existence of the cause)”, the subset is changed to “0 (non-existence of the link)”. In addition, in a case where the subset is “0 (non-existence of the link)” and the domain, knowledge is “1 (existence of the cause)”, the subset is changed to “1 (existence of the link)”. In a case where the subset is “0 (non-existence of the link)” and the domain knowledge is “0∞ (non-existence of the cause)”, the subset maintains “0 (non-existence of the link)” without change. In addition, in a case where the domain knowledge is “N (non-existence of knowledge)”, a priority is given to the subset and the subset is not corrected.

(3) Control Section 30

The control section 30 mainly includes the initial causal relation model construction condition setting section 31, the data aggregation section 32, the causal relation model construction section 33, the subset extraction section 34, the subset and domain knowledge verification section 15, and the causal relation model construction condition restriction setting section 36.

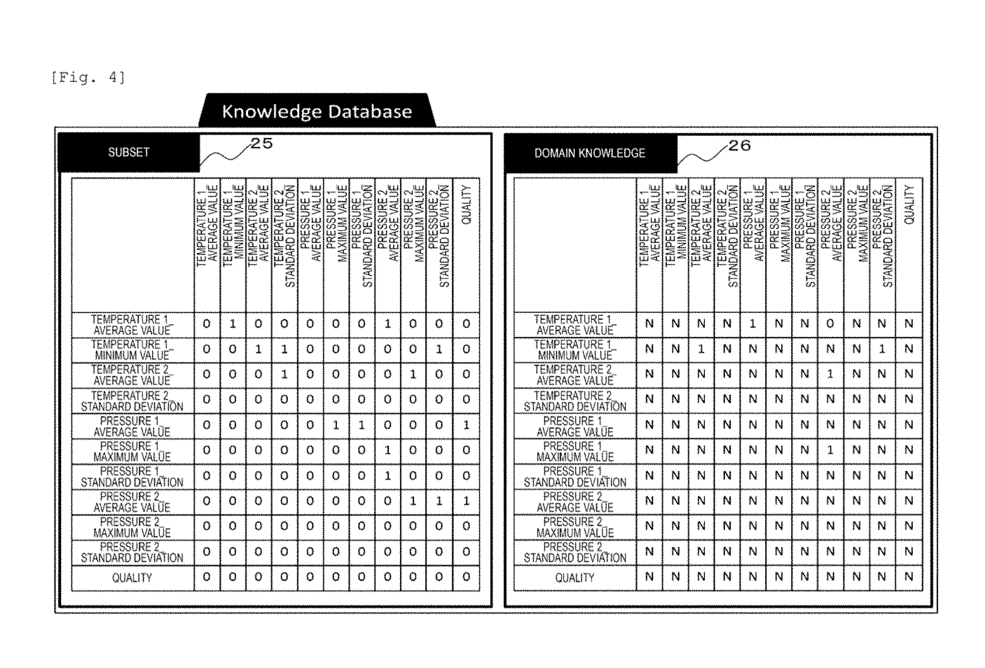

An example of a processing flow performed by the control section 30 will be described with reference to FIG. 5. First, the monitor data is acquired from facilities and sensors on the manufacturing process, the quality data is acquired from, facilities and sensors on the quality testing process, and the domain knowledge and the causal relation model construction condition are acquired (S3000). The data may be acquired through the input and output section 10 and may be stored as data in the storage section 40.

Subsequently, the initial causal relation model construction condition is set based on the acquired data (S3001). Here, the initial causal relation model construction condition, which is an initial condition in a case where the causal relation model is constructed, is set based on the acquired causal relation model construction condition and the causal relation model construction condition restriction acquired through a subsequent processing. S3001 is relevant to a function of the initial causal relation model construction condition setting section 31.

Subsequently, the acquired monitor data and the quality data are aggregated (S3002). S3002 is relevant to a function of the data aggregation section 32. In a manufacturing site, there are many cases in which the monitor data acquired based on the manufacturing process is written for each time series and the quality data acquired based on the quality verification process is written for each product, and thus it is necessary to combine granularities of the monitor data and the quality data. In S3002, data are aggregated by combining the quality data with the data item using a method for setting the monitor data as a representative value.

Subsequently, the causal relation model is constructed using the set initial causal relation model construction condition (S3003). S3003 is relevant to the causal relation model construction section 33. A method for constructing the causal relation model is disclosed in PTL 1 or the like.

Subsequently, a certain index which expresses the strength of the causal relation of the monitor data with respect to the quality data is calculated based on the acquired causal relation model (S3004). As described above, an example of the index includes the difference in the expected values. However, the index is not limited thereto.

The threshold is set with respect to the calculated index and the monitor data having an index which is equal to or larger than the threshold is extracted as the subset (S3005). S3004 and S3005 are relevant to the function of the subset extraction section 34.

Subsequently, the extracted subset of the monitor data and the domain knowledge are verified (S3006). S3006 is relevant to a function of the subset and domain knowledge verification section 35. In a case where the domain knowledge acquired by the input and output section 10 and the subset of the monitor data extracted by the subset extraction section 34 have different data formats, the domain knowledge is compared with the subset by expressing, for example, a duality chart according to the data item of the monitor data.

In a case where a contradictory part exists as a result of comparison of the extracted, subset of the monitor data and the domain knowledge, the causal relation model construction condition restriction is set in order to add a condition for solving the contradiction in a case where the causal relation model is constructed again (S3007). The condition is added in such a way that, for example, in a case where the subset is “1 (existence of the link)” and the domain knowledge is “0 (non-existence of the cause)” as in the above-described example, a condition in which the subset is prohibited from being linked is added. Although it is possible to automatically perform the setting and a process of reconstructing the model, it is also possible to manually set the causal relation model construction condition restriction. S3007 is relevant to a function of the causal relation model construction condition restriction setting section 36.

In a case where a contradictory part does not exist as a result of comparison of the extracted subset of the monitor data and the domain knowledge, the constructed causal relation model, the extracted subset of the monitor data, the index acquired in a case where the subset is extracted, and the domain knowledge are respectively displayed on the causal relation model display section 21, the subset graph display section 22, the threshold adjustment display section 23, the subset extraction index display section 24, the subset display section 25, and the domain knowledge display section 26, and the display section 20 is updated (S3008).

(4) Storage Section 40

The storage section 40 mainly includes the monitor data storage section 41, the quality data storage section 42, the causal relation model construction condition storage section 43, a causal relation model storage section 44, a subset storage section 45, a subset extraction index storage section 46, a domain knowledge storage section 47, and the causal relation model construction condition restriction storage section 48.

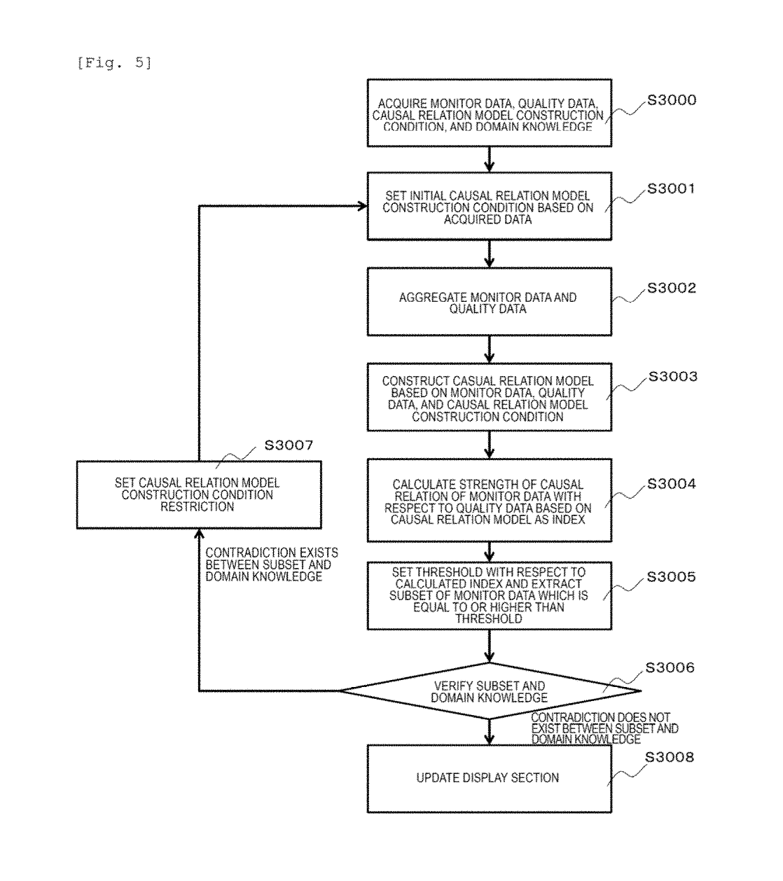

FIG. 6 illustrates an example of a data definition diagram of the monitor data stored in the monitor data storage section 41. A first row indicates header information, a first column indicates a product ID given to each product, a second column indicates data acquisition time, and a third and subsequent columns indicate values for respective monitor data.

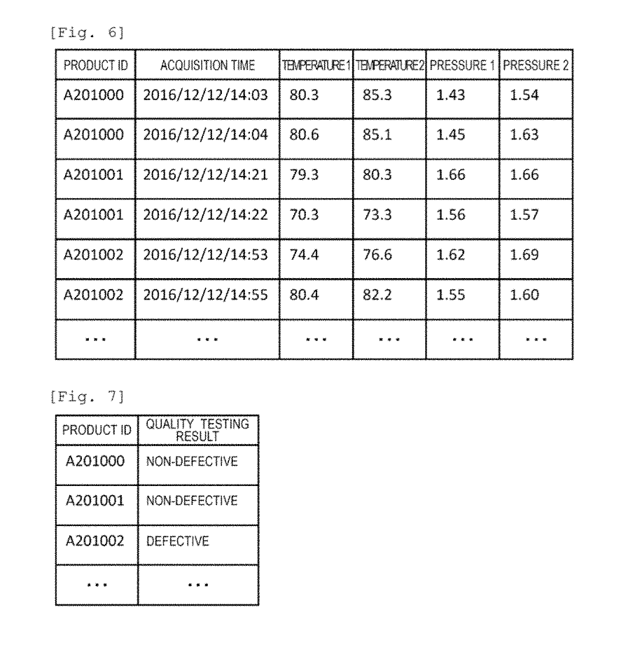

FIG. 7 illustrates an example of the data definition diagram of the quality data stored in the quality data storage section 42. A first row indicates header information, a first column indicates a product ID given to each product, and a second column indicates a quality testing result. The quality testing result may be expressed by displaying qualities in stages in addition to non-defective and defective.

The causal relation model construction condition storage section 43 stores the model construction condition, such as an algorithm name and various setting values which are used in a case where the causal relation model is constructed based on the monitor data and the quality data.

The causal relation model storage section 44 stores the causal relation model constructed through S3003 illustrated in FIG. 5.

The subset storage section 45 stores the subset of the monitor data extracted through S3004 and S3005 illustrated in FIG. 5.

The subset extraction index storage section 46 stores an index used in a case where the subset of the monitor data is extracted from the causal relation model in S3005 illustrated in FIG. 5.

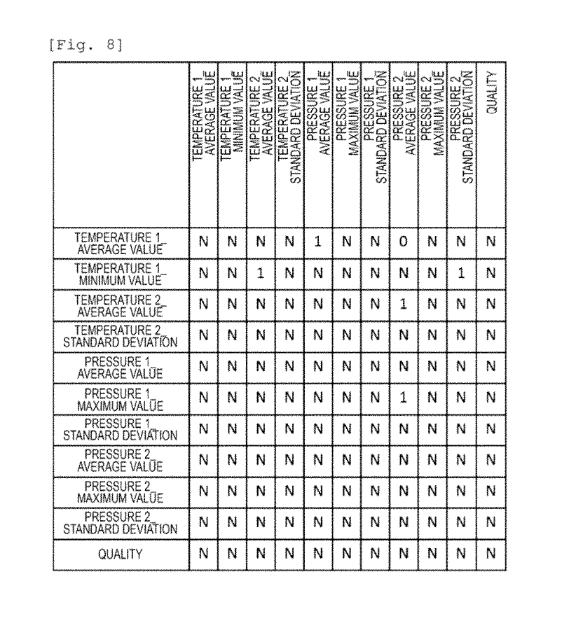

FIG. 8 is a data definition diagram of the domain knowledge stored in the domain knowledge storage section 47. A first row and a first column indicate data items of the monitor data and the qualify data. The second row and the second column express the causal relation between the monitor data acquired based on the domain knowledge and the causal relation between the monitor data and the quality data as non-existence of the cause in a case of 0, existence of the cause in a case of 1, and existence/non-existence of the cause is not clear in a case of N.

The causal relation model construction condition restriction storage section 48 stores the causal relation model construction condition restriction set in S3007 illustrated in FIG. 5.

According to the example, it is possible to provide a system which takes the strength of the causal relation between the quality data and the monitor data into consideration, which can extract the subset of the monitor data without omission, which verifies the subset and the domain knowledge, and which automatically inputs the domain knowledge restriction condition, thereby reducing verification time of the causal relation model and the domain knowledge even in a case where the number of data items is large.

Hereinabove, although the present invention invented by the inventor has been described in detail based on the embodiment, the present invention is not limited to the embodiment, and it is that various modifications are possible without departing from the gist of the invention.

The present invention is not limited to the above-described embodiment and includes various modified examples. For example, it is possible to replace a part of a configuration of a certain example with a configuration of another example. In addition, it is possible to add the configuration of another example to the configuration of the certain example. In addition, it is possible to perform addition, removal, and replacement of the configuration of another example on the part of the configuration of each example.

### REFERENCE SIGNS LIST

1: failure cause extraction system

10: input and output section

20: display section

21: causal relation model display section

22: subset graph display section

23: threshold adjustment display section

24: subset extraction index display section

25: subset display section

30: control section

31: initial causal relation model construction condition setting section

32: data aggregation section

33: causal relation model construction section

34: subset extraction section

35: subset and domain knowledge verification section

36: causal relation, model construction condition restriction setting section

40: storage section

41: monitor data storage section

42: quality data storage section

43: causal relation model construction condition storage section

44: causal relation model storage section

45: subset storage section

46: subset extraction index storage section

47: domain knowledge storage section

48: causal relation model construction condition restriction storage section

1. A causal relation model verification method in an information processing device which includes an input device, a display device, a processing device, and a storage device, the method comprising:
a first step of acquiring quality data which is an evaluation result of a resulting product, monitor data which indicates a parameter in a case where the resulting product is generated, and domain knowledge which indicates a mutual relation between the quality data and the monitor data from the input device or the storage device;
a second step of constructing the causal relation model which defines a relation between nodes by setting the quality data and the monitor data to the nodes, using a causal relation model construction condition, which is acquired from the input device or the storage device, by the processing device; and
a third step of performing at least one of a comparison processing performed by the processing device and a comparison display performed by the display device on the causal relation model and the domain knowledge.

2. The causal relation model verification method according to claim 1, further comprising:
a fourth step of correcting the causal relation model based on a result of the third step.

3. The causal relation model verification method according to claim 2,
wherein, in the fourth step, the processing device adds a restriction condition to the causal relation model construction condition used in the second step in order to correct the causal relation model.

4. The causal relation model verification method according to claim 3,
wherein, in the third step, the processing device detects a contrariety between the causal relation model and the domain knowledge, and
wherein, in the fourth step, the processing device generates a causal relation model construction condition restriction in order to solve the contrariety as the restriction condition.

5. The causal relation model verification method according to claim 4,
wherein the second step, the third step, and the fourth step are sequentially performed, and a process returns to the second step after the fourth step is performed, and
wherein, in the second step, the causal relation model is constructed in such a way that the causal relation model construction condition restricted by the causal relation model construction condition restriction is set as a new initial condition.

6. The causal relation model verification method according to claim 1,
wherein, in the third step, the causal relation model and data of the domain knowledge, which are stored in the storage device, are used, and
wherein both the causal relation model and the data of the domain knowledge include a set of a parameter that specifies the quality data or the monitor data, which configures a first node, a parameter that specifies the quality data or the monitor data, which configures a second node, and a parameter that defines a relation between the first node and the second node.

7. The causal relation model verification method according to claim 1,
wherein, in the third step, a subset of the monitor data, which has prescribed or more influence on the quality data, is extracted based on the causal relation model, and at least one of the comparison processing and the comparison display of the subset and the domain knowledge is performed.

8. The causal relation model verification method according to claim 7,
wherein, in a case where the subset of the monitor data, which has the prescribed or more influence on the quality data, is extracted from the causal relation model, a difference in expected values of the monitor data is used as an index in a case where different qualities appear.

9. The causal relation model verification method according to claim 8,
wherein the display device displays a graphical user interface for changing a threshold with respect to the index.

10. A failure cause extraction system comprising:
an input section that acquires monitor data which indicates a state of a product manufacturing process, quality data which is a result of a quality testing process of the product, a causal relation model construction condition which indicates a condition in a case where a causal relation model is constructed, and domain knowledge of a target manufacturing process;
an initial causal relation model construction condition setting section that sets an initial causal relation model construction condition, which is an initial condition in the case where the causal relation model is constructed, using the causal relation model construction condition;
a data aggregation section that aggregates the monitor data and the quality data as manufacturing data;
a causal relation model construction section that constructs the causal relation model based on the manufacturing data and the initial causal relation model construction condition;
a subset extraction, section that extracts a subset of the monitor data, which has prescribed or more influence on the quality data, based on the causal relation model constructed by the causal relation model construction section;
a subset and domain knowledge verification section that verifies the subset of the monitor data, which is extracted by the subset extraction section, and the domain knowledge; and
a causal relation model construction condition restriction setting section that sets a causal relation model construction condition restriction which restricts the causal relation model construction condition in a case where a contradiction exists between the subset of the monitor data and the domain knowledge as a result of verification performed by the subset and domain knowledge verification section.

11. The failure cause extraction system according to claim 10,
wherein the initial causal relation model construction condition setting section sets the initial causal relation model construction condition using the causal relation model construction condition and the causal relation model construction condition restriction.

12. The failure cause extraction system according to claim 10,
wherein the subset extraction section calculates an index of the monitor data based on strength of the causal relation with the quality data, and extracts the subset of the monitor data by providing a threshold with respect to the index.

13. The failure cause extraction system according to claim 10,
wherein the subset and domain knowledge verification section compares the domain knowledge acquired in the input section with the subset of the monitor data extracted in the subset extraction section.

14. A causal, relation model verification system, which includes an input device, a display device, a processing device, and a storage device,
wherein the causal relation model verification system is capable of using quality data which is an evaluation result of a resulting product, monitor data which indicates a parameter in a case where the resulting product is generated, domain knowledge data which indicates a mutual relation between the quality data and the monitor data, and causal relation model construction condition data,
wherein the processing device constructs a causal relation model which defines a relation between nodes by setting the quality data and the monitor data as the nodes according to a condition indicated by the causal relation model construction condition data,
wherein the processing device stores the causal relation model in the storage device,
wherein the processing device detects mutual contrarieties according to a comparison processing performed on the causal relation model and the domain knowledge data, and
wherein the processing device adds a restriction condition to a condition of the causal relation model construction condition data such that the detected contrarieties are solved, and corrects the causal relation model.

15. The causal relation model verification system according to claim 14,
wherein, in a case where mutual contrarieties are detected by performing the comparison processing on the causal relation model and the domain knowledge data, the processing device extracts a subset, which includes a part of the monitor data that has prescribed or more influence on the quality data, in the causal relation model, and performs the comparison processing on the subset and the domain knowledge data.
